(19) United States
(12) Patent Application Publication
(10) Pub. No.: US 2012/0214588 A1
(43) Pub. Date: Aug. 23, 2012

(54) GAME CONTROLLER WITH PROJECTION FUNCTION

(75) Inventors: QIANG YOU, Shenzhen City (CN); REN-WEN HUANG, Shenzhen City (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/050,958

(22) Filed: Mar. 18, 2011

(30) Foreign Application Priority Data
Feb. 18, 2011 (CN) 201110042333.7

(51) Int. Cl. A63F 13/00

(52) U.S. Cl. 463/31

(57) ABSTRACT

A game controller connected to a game console includes an input unit, a video access unit, a projection unit, an angle detection unit, and a processing unit. The input unit generates control signals according to user input for controlling games. The video access unit receives video signals from the game console. The projection unit includes a lens module to projects game images onto a projection surface and a driving module to adjust the projection direction of the lens module. The angle detection unit detects a tilt angle of the game controller. The processing unit controls game play according to the control signals and generates an adjusting signal including a change of the tilt angle. The adjusting signal is sent to the driving module to adjust the projection direction of the lens module.

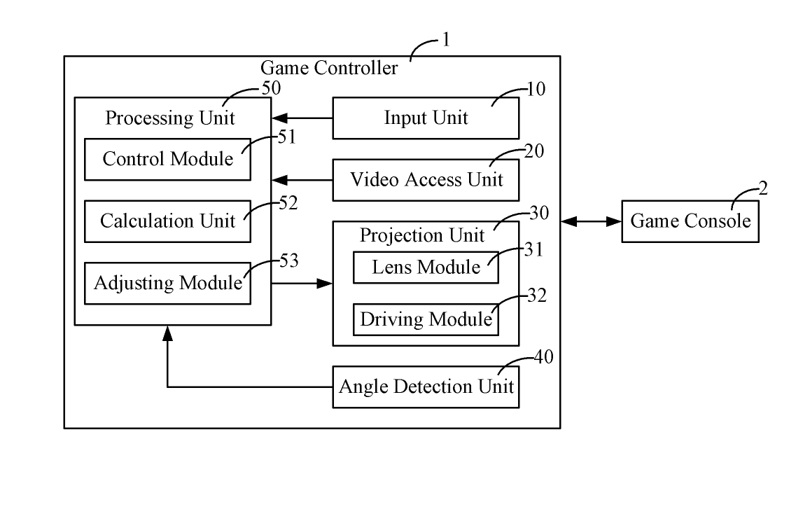

### BACKGROUND

1. Technical Field

The present disclosure relates to game controllers, and particularly, to a game controller capable of projecting game images onto a surface.

2. Description of Related Art

Home game consoles, such as Sony PlayStation™, Nintendo Wii™, and Microsoft X-box™, are generally connected to a display device and a game controller. The display device is used to display the game, and the controller is used to control the game. However, it is inconvenient for users to bring both the display device and the game controller along with the game console to another location.

### BRIEF DESCRIPTION OF THE DRAWINGS

The components of the drawing are not necessarily drawn to scale, the emphasis instead being placed upon clearly illustrating the principles of a game controller with projection function.

The drawing is a block diagram of a game controller according to an exemplary embodiment.

### DETAILED DESCRIPTION

Referring to the drawing, a game controller 1 is connected to a game console 2 for interfacing with a game. The game controller 1 can also project game images onto a surface such as a projection screen or wall. The game controller 1 includes an input unit 10, a video access unit 20, a projection unit 30, an angle detection unit 40, and a processing unit 50.

The input unit 10 generates control signals corresponding to user input for playing the game.

The video access unit 20 receives video signals through wired or wireless communication from the game console 2.

The projection unit 30 includes a lens module 31 and a driving module 32. The lens module 31 projects images corresponding to the received video signals onto the surface. The driving module 32 can adjust the projection direction of the lens module 31.

The angle detection unit 40 detects a tilt angle of the game controller 1. In the embodiment, the angle detection unit 40 is a gyroscope.

The processing unit 50 includes a control module 51, a calculation module 52, and an adjusting module 53.

The control module 51 controls game play according to the control signals provided by the input unit 10.

The calculation module 52 calculates a change of the tilt angles detected by the angle detection unit 40.

The adjusting module 53 generates an adjusting signal including the change of the tilt angles provided by the calculation module 52. The adjusting signal is sent to the driving module 32. The driving module 32 adjusts the projection direction of the lens module 31 correspondingly to assure that the game image is steady on the projection surface.

With such configuration, the game controller 1 is capable of projecting the game image of the received game from the game console 2. There is no need to take a display device along with the game console 2, which is very convenient for gamers.

While various embodiments have been described and illustrated, the disclosure is not to be constructed as being limited thereto. Various modifications can be made to the embodiments by those skilled in the art without departing from the true spirit and scope of the disclosure as defined by the appended claims.

1. A game controller to be connected to a game console for interfacing with a game, the game controller comprising:
an input unit to generate control signals corresponding to user input for playing the game;
a video access unit to receive video signals from the game console;
a projection unit comprising a lens module and a driving module, wherein the lens module is configured to project game images corresponding to the received video signals with a projection direction onto a surface, and the driving module is capable of adjusting the projection direction of the lens module;
an angle detection unit to detect a tilt angle of the game controller; and
a processing unit to control game play according to the control signals and generate an adjusting signal comprising a change of the tilt angle detected by the angle detection unit, which is sent to the driving module for adjusting the projection direction of the lens module, thereby assuring that the game images are steady on the projection surface.

2. The game controller as described in claim 1, wherein the angle detection unit is a gyroscope.

3. The game controller as described in claim 1, wherein the processing unit comprises a control module to control game play according to the control signals provided by the input unit.

4. The game controller as described in claim 1, wherein the processing unit comprises a calculation module to calculate the change of the tilt angles.

5. The game controller as described in claim 1, wherein the processing unit further comprises an adjusting module to generate an adjusting signal comprising the change of tilt angles, which is sent to the driving module for adjusting the projection direction of the lens module.
